(19) United States
(12) Patent Application Publication
(10) Pub. No.: US 2005/0240530 A1
(43) Pub. Date: Oct. 27, 2005

(54) Content distribution system, playback apparatus, content server, usage rule server, accounting server, playback method, content transmission method, usage rule transmission method, accounting method, program, and storage medium

(76) Inventors: Akihiro Watanabe, Kanagawa (JP); Katsunori Hashimoto, Tokyo (JP); Yoshiharu Dewa, Tokyo (JP); Yasuaki Yamagishi, Kanagawa (JP)

Correspondence Address: FROMMER LAWRENCE & HAUG LLP, 745 FIFTH AVENUE, NEW YORK, NY, 10151, US

(21) Appl. No.: 11/110,615

(22) Filed: Apr. 20, 2005

(30) Foreign Application Priority Data
Apr. 22, 2004 (JP) P2004-126412

(51) Int. Cl. G06F 17/60; H04K 1/00; H04L 9/00

(52) U.S. Cl. 705/52

(57) ABSTRACT

In a content distribution system, a content provider transmits a motion picture content and usage rule metadata to a playback apparatus. In the usage rule metadata, a rule of secondary use of the motion picture content is prescribed. The playback apparatus has a controller that analyzes the usage rule metadata and controls the operation of the playback apparatus such that a still image is allowed to be extracted from the motion picture content within the limit prescribed in the usage rule. When a user extracts a still image, the playback apparatus generates user metadata in terms of extraction and transmits it to an accounting system. The accounting system performs an accounting process based on the received user metadata. Thus, users are allowed to extract still images from motion picture contents within the limit prescribed by content providers in usage rules, and content providers perform the accounting process to charge fees for secondary use of motion picture contents.

### BACKGROUND OF THE INVENTION

1. Field of the Invention

The present invention relates to a content distribution system, a playback apparatus, a content server, a usage rule server, an accounting server, a playback method, a content transmission method, a usage rule transmission method, an accounting method, a program, and a storage medium, and more particularly to a technique of secondary usage of a content according to a usage rule.

2. Description of the Related Art

Digital contents are widely distributed via the Internet which has become very popular or via digital broadcasting which has been started recently. For example, in digital broadcasting, a program (motion picture content) broadcast on a broadcast wave is received and played back by a digital broadcast playback apparatus (a television receiver, a set top box, or the like) of a user. In some cases, a playback apparatus is connected to a broadcast station via the Internet to achieve two-way communication between a user and the broadcast station.

The set top box is an information terminal for receiving a cable television broadcast or a digital broadcast. Many set top boxes have a capability of recording a program on a hard disk disposed therein and a capability of network connection. A set top box is placed, for example, on the top of a television receiver such that a program received via the set top box can be displayed on the television receiver.

A state-of-the-art playback apparatus has a capability of recording a program on a high-capacity hard disk or a DVD (Digital Versatile Disk) and has a large and thin screen such as a plasma display panel or a liquid crystal display panel. Digital contents can be copied without degradation in image quality. This has brought about a serious problem of protecting copyright of digital contents.

In general, additional information called metadata is attached to a digital content. In metadata, information associated with a content such as a title, a summary, and a start/end time of the content is described. Metadata is used for various purposes. For example, retrieval can be performed based on metadata.

For example, in an information processing apparatus disclosed in Japanese Unexamined Patent Application Publication No. 2003-203080, metadata is attached to each digital image taken by a user so that digital images can be retrieved or managed based on the metadata.

### SUMMARY OF THE INVENTION

In a current content distribution system, a technique of protecting copyright of contents in secondary use of contents is not established. In most cases, copyright is protected simply by prohibiting secondary use, although there is a need for secondary use. For example, if a part of a broadcast motion picture content is allowed to be extracted as a still image, it can be used as interior decoration by displaying it an displayed on a large-size display.

Some hard disk recording apparatus has a capability of storing a still image taken by a digital camera and outputting it on a large-size display. If a still image with a high resolution is extracted from a high-vision broadcast program, the resultant still image will have high quality similar to that of a poster or a painted picture.

To realize secondary use of motion picture contents in such a manner or other various manners, it is necessary to establish a technique to allow secondary use while protecting copyright of contents. According to embodiments of the invention, a playback apparatus is controlled such that secondary use of a content by a user is allowed within a limit prescribed in a usage rule.

According to an embodiment, the present invention provides a content distribution system including a server system for providing a content and a usage rule of the content, a playback apparatus for acquiring the content and the usage rule from the server system and playing back the content, the playback apparatus being allowed to acquire corresponding information corresponding to a particular part of the played-back content and play back the acquired corresponding information within a limit prescribed in the usage rule, and an accounting server for receiving history information in terms of the corresponding information acquired by the playback apparatus and performing an accounting process based on the history information.

According to an embodiment, the present invention also provides a playback apparatus including content reception means for receiving a content, usage rule acquisition means for acquiring a usage rule of the content, playback means for playing back the received content, designation acceptance means for accepting designation of a particular part of the content played back by the playback means, and corresponding information acquisition means for acquiring corresponding information which corresponds to the designated particular part and which is capable of being played back by the playback means within the limit prescribed in the acquired usage rule.

In this playback apparatus, the corresponding information acquisition means may acquire the corresponding information by extracting the corresponding information from the content.

The playback apparatus may further include particular part designation information transmission means for transmitting designation information designating the particular part to the content server, wherein the corresponding information acquisition means may receive, from the content server, corresponding information corresponding to the particular part designated by the transmitted designation information.

In this playback apparatus, the content reception means may receive, together with the content, a plurality of pieces of related information related to the content, and the corresponding information acquisition means may acquire related information corresponding to the designated particular part as the corresponding information.

In this playback apparatus, the content reception means may receive, together with the content, a plurality of pieces of encrypted corresponding information related to the content, and the playback apparatus may further include decryption key request means for requesting the content server to provide a decryption key to be used to decrypt related information corresponding to the designated particular part, and decryption key reception means for receiving the requested decryption key from the content server, and wherein the corresponding information acquisition means may acquire the corresponding information by decrypting, using the received decryption key, the related information corresponding to the designated particular part.

The playback apparatus may further include corresponding information usage rule acquisition means for acquiring a corresponding information usage rule of the acquired corresponding information, and corresponding information transmission means for transmitting the corresponding information and the acquired corresponding information usage rule to another playback apparatus.

The playback apparatus may further include history information generation means for generating history information in terms of acquisition of corresponding information, and history information transition means for transmitting the generated history information to the accounting server.

According to an embodiment, the present invention also provides a content server for transmitting a content to a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the content server including content transmission means for transmitting a content to the playback apparatus, and usage rule transmission means for transmitting a usage rule of the content to the playback apparatus.

The content server may further include particular part designation information reception means for receiving designation information designating the particular part from the playback apparatus, and corresponding information transmission means for transmitting corresponding information corresponding to the particular part designated by the received designation information to the playback apparatus.

The content server may further include related information transmission means for transmitting to the playback apparatus, together with the content, a plurality of pieces of related information that are related to the content and that are usable as the corresponding information.

The content server may further include related information transmission means for transmitting, to the playback apparatus, a plurality of pieces of decrypted related-information that are related to the content and that are usable as the corresponding information, request acceptance means for accepting a request for a decryption key used to decrypt the related information, and decryption key transmission means for transmitting the requested decryption key to the playback apparatus.

According to an embodiment, the present invention also provides a usage rule server for transmitting a usage rule to a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the usage rule server including identification information reception means for receiving identification information identifying a content from the playback apparatus, and usage rule transmission means for retrieving a usage rule corresponding to the received identification information and transmitting the retrieved usage rule to the playback apparatus.

According to an embodiment, the present invention also provides an accounting server for performing an accounting process based on history information in terms of acquisition of corresponding information-performed by a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the accounting server including history information acquisition means for acquiring the history information, and accounting means for performing the accounting process based on the acquired history information.

According to an embodiment, the present invention also provides a playback method using a computer including content reception means, usage rule acquisition means, playback means, designation acceptance means, and corresponding information acquisition means, the method including the steps of receiving a content by the content reception means, acquiring a usage rule of the content by the usage rule acquisition means, playing back the received content by the playback means, accepting, by the designation acceptance means, designation of a particular part of the content played back by the playback means, and acquiring corresponding information which corresponds to the designated particular part and which is capable of being played back by the playback means within the limit prescribed in the acquired usage rule.

In the playback method, the corresponding information acquisition step may include extracting the corresponding information from the content to acquire the corresponding information.

In the playback method, the computer may further include particular part designation information transmission means, and the method may further include the step of transmitting designation information designating the particular part to the content server, wherein the corresponding information acquisition step may include receiving, from the content server, corresponding information corresponding to the particular part designated by the transmitted designation information.

In the playback method, the content reception step may include receiving, together with the content, a plurality of pieces of related information related to the content, and the corresponding information acquisition step may include acquiring related information corresponding to the designated particular part as the corresponding information.

In the playback method, the computer may further include decryption key request means and decryption key reception means, the content reception step may include receiving, together with the content, a plurality of pieces of encrypted corresponding information related to the content, and the method may further include the steps of requesting, by the decryption key request means, the content server to provide a decryption key to be used to decrypt related information corresponding to the designated particular part, and receiving the requested decryption key from the content server, by the decryption key reception means, wherein the corresponding information acquisition step may include acquiring the corresponding information by decrypting, using the received decryption key, the related information corresponding to the designated particular part.

In the playback method, the computer may further include corresponding information usage rule acquisition means and corresponding information transmission means, and the method may further include the steps of acquiring, by the corresponding information usage rule acquisition means, a corresponding information usage rule of the acquired corresponding information, and transmitting, by the corresponding information transmission means, the corresponding information and the acquired corresponding information usage rule to another playback apparatus.

In the playback method, the computer may further include history information generation means and history information transmission means, and the method may further include the steps of generating, by the history information generation means, history information in terms of acquisition of corresponding information, and transmitting, by the history information transmission means, the generated history information to an accounting server.

According to an embodiment, the present invention also provides a content transmission method of transmitting, using a computer, a content to a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the computer including content transmission means and usage rule transmission means, the method including the steps of transmitting, by the content transmission mean, a content to the playback apparatus, and transmitting, by the usage rule transmission means, a usage rule of the content to the playback apparatus.

In the content transmission method, the computer may further include a particular part designation information reception means and corresponding information transmission means, and the method may further include the steps of receiving, by the particular part designation information reception means, designation information designating the particular part from the playback apparatus, and transmitting, by the corresponding information transmission means, corresponding information corresponding to the particular part designated by the received designation information to the playback apparatus.

In the content transmission method, the computer may further include related information transmission means, and the method may further include the step of transmitting, by the related information transmission means, to the playback apparatus together with the content, a plurality of pieces of related information that are related to the content and that are usable as the corresponding information.

In the content transmission method, the computer may further include related information transmission means, request acceptance means, and decryption transmission means, and the method may further include the steps of transmitting, by the related information transmission means, to the playback apparatus, a plurality of pieces of related information that are related to the content and that are usable as the corresponding information, accepting, by the request acceptance means, a request for a decryption key used to decrypt the related information, and transmitting, by the decryption key transmission means, the requested decryption key to the playback apparatus.

According to an embodiment, the present invention also provides a usage rule transmission method of transmitting, using a computer, a usage rule to a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the computer including identification information reception means and usage rule transmission means, the method including the steps of receiving, by the identification information reception means, identification information identifying a content from the playback apparatus, and transmitting, by the usage rule transmission means, a usage rule to the playback apparatus, the usage rule being obtained by retrieving the usage rule corresponding to the received identification information.

According to an embodiment, the present invention also provides an accounting method of performing, by a computer, an accounting process based on history information in terms of acquisition of corresponding information performed by a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the computer including history information acquisition means and accounting means, the method including the steps of acquiring the history information by the history information acquisition means, and performing, by the accounting means, an accounting process based on the acquired history information.

According to an embodiment, the present invention also provides a program for implementing functions on a computer, the functions including a function of receiving a content, a function of acquiring a usage rule of the content, a function of playing back the received content, a function of accepting designation of a particular part of the content played back by the playback function, and a function of acquiring corresponding information which corresponds to the designated particular part and which is capable of being played back by the playback function within the limit prescribed in the acquired usage rule.

In this program, the corresponding information acquisition function may include acquiring the corresponding information by extracting the corresponding information from the content.

The program may further implement, on the computer, a function of transmitting designation information designating the particular part to a content server, and the corresponding information acquisition function may include receiving, from the content server, corresponding information corresponding to the particular part designated by the transmitted designation information.

In the program, the content reception function may include receiving, together with the content, a plurality of pieces of related information related to the content, and the corresponding information acquisition function may include acquiring related information corresponding to the designated particular part as the corresponding information.

In the program, the content reception function may include receiving, together with the content, a plurality of pieces of encrypted corresponding information related to the content, and the program may further implement, on the computer, a decryption key request function of requesting the content server to provide a decryption key to be used to decrypt related information corresponding to the designated particular part, and a decryption key reception function of receiving the requested decryption key from the content server, wherein the corresponding information acquisition function may include acquiring the corresponding information by decrypting, using the received decryption key, the related information corresponding to the designated particular part.

The program may further implement, on the computer, a corresponding information usage rule acquisition function of acquiring a corresponding information usage rule of the acquired corresponding information, and a corresponding information transmission function of transmitting the corresponding information and the acquired corresponding information usage rule to another program.

The program may further implement, on the computer, a history information generation function of generating history information in terms of acquisition of corresponding information, and a history information transition function of transmitting the generated history information to an accounting server.

According to an embodiment, the present invention also provides a program for implementing, on a computer, a function of transmitting a content to a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the function including a content transmission function of transmitting a content to the playback apparatus, and a usage rule transmission function of transmitting a usage rule of the content to the playback apparatus.

The program may further implement, on the computer, a particular part designation information reception function of receiving designation information designating the particular part from the playback apparatus, and a corresponding information transmission function of transmitting corresponding information corresponding to the particular part designated by the received designation information to the playback apparatus.

The program may further implement, on the computer, a related information transmission function of transmitting to the playback apparatus, together with the content, a plurality of pieces of related information that are related to the content and that are usable as the corresponding information.

The program may further implement, on the computer, a related information transmission function of transmitting, to the playback apparatus, a plurality of pieces of decrypted related-information that are related to the content and that are usable as the corresponding information, a request acceptance function of accepting a request for a decryption key used to decrypt the related information, and a decryption key transmission function of transmitting the requested decryption key to the playback apparatus.

According to an embodiment, the present invention also provides a program for implementing, on a computer, a function of transmitting a usage rule to a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the function including an identification information reception function of receiving identification information identifying a content from the playback apparatus, and a usage rule transmission function of retrieving a usage rule corresponding to the received identification information and transmitting the retrieved usage rule to the playback apparatus.

According to an embodiment, the present invention provides a program for implementing, on a computer, a function of performing an accounting process based on history information in terms of acquisition of corresponding information performed by a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the function including a history information acquisition function of acquiring the history information, and an accounting function of performing the accounting process based on the acquired history information.

The present invention also provides a computer-readable storage medium on which a program according to one of the embodiments described above is stored.

Thus, embodiments of the present invention make it is possible for a user to enjoy secondary use of a content within a limit prescribed in a usage rule.

### BRIEF DESCRIPTION OF THE DRAWINGS

FIG. 1 is a diagram illustrating an example of a content distribution system according to an embodiment;

FIG. 2 is diagram showing functional blocks of a playback apparatus and a content server;

FIG. 3 is a flow chart showing a process of using still image extraction service on a playback apparatus;

FIG. 4 is a diagram showing an example of usage rule metadata;

FIG. 5 is a diagram showing an example of user metadata;

FIG. 6 is a block diagram showing a hardware configuration of a playback apparatus;

FIG. 7 is a flow chart illustrating a manner in which a member of “Picture Club” and a non-member acquire still image data;

FIG. 8 is a diagram showing an example of a membership registration license;

FIG. 9 is a diagram showing an example of a content license;

FIG. 10 is a diagram showing an example of usage rule metadata in which service for a limited period is prescribed;

FIG. 11 is a diagram showing an example of usage rule metadata in which print service is prescribed;

FIG. 12 is a diagram showing an example of usage rule metadata in which still image exchange service among users is prescribed;

FIG. 13 is a diagram showing an example of usage rule metadata in which music content purchase service is prescribed; and

FIG. 14 is a diagram showing an example of usage rule metadata in which purchasing of making contents is prescribed.

### DESCRIPTION OF THE EMBODIMENTS

### Overview of Embodiments

The limit of secondary use of a-motion picture content by a user is prescribed in metadata attached to the content. A playback apparatus controls secondary use of the motion picture content within the limit prescribed in the metadata.

In embodiments described below, by way of example, a still image is extracted for the purpose of secondary use from a motion picture content.

A content provider transmits usage rule metadata together with a motion picture content to a playback apparatus. In the usage rule metadata, a rule of secondary use of the motion picture content is prescribed (for example, allowance/prohibition of extraction of a still image is prescribed).

A playback apparatus analyzes the usage rule metadata and controls secondary use of the motion picture content such that extraction of a still image from the motion picture content is allowed within the limit prescribed in the usage rule metadata. When a user extracts a still image, the playback apparatus generates user metadata in terms of extraction and transmits it to an accounting system. The accounting system performs an accounting process based on the received user metadata.

Thus, users are allowed to extract still images from motion picture contents within the limit prescribed by content providers in usage rules, and content providers perform an accounting process to charge fees for secondary use of motion picture contents.

### DETAILED DESCRIPTION OF EMBODIMENTS

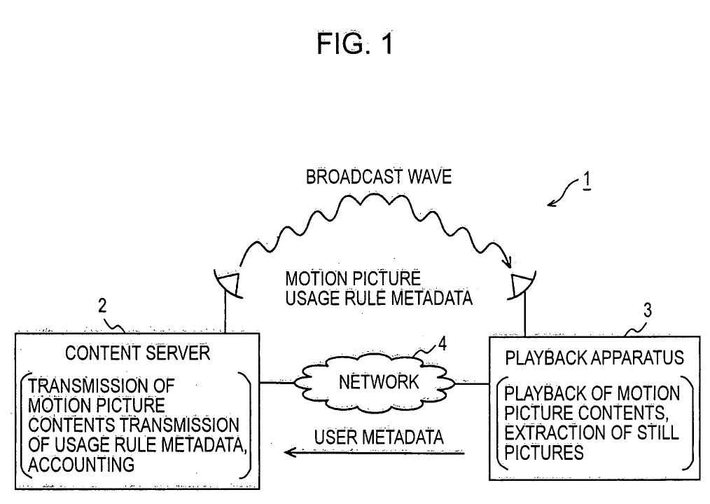

FIG. 1 is a diagram illustrating an example of a content distribution system according to the present embodiment. The content distribution system 1 includes a content server 2 and a playback apparatus 3 connectable to the content server 2 via a network 4. Although the content distribution system 1 includes a plurality of playback apparatuses, only one playback apparatus 3 is shown as a typical example in FIG. 1.

The content server 2 is installed in a broadcasting station run by a content provider organization and the content server 2 performs transmission of motion picture contents, transmission of usage rule metadata, and accounting associated with acquisition of still images. Although in the present embodiment, by way of example, the content server 2 has all these three capabilities, each capability may be separately implemented by different server apparatuses responsible for provision of contents, provision of usage rule metadata, and accounting process.

The content server 2 is connected to a broadcasting system having an antenna for emitting a broadcast wave (radio wave) into space. The content server 2 transmits a broadcast wave carrying a motion picture content and usage rule metadata. The broadcast wave may be directly transmitted to an antenna of the playback apparatus 3 from the antenna of the broadcasting station, or may be transmitted via a broadcasting satellite or a communication satellite. The broadcast wave may also be transmitted via a communication medium such as an optical cable.

The broadcast wave has a content band for transmission of a motion picture content and a data band for transmission of associated data. The content server 2 transmits usage rule metadata by using the data band. The usage rule data is transmitted at a plurality of times by a data carousel method during broadcast of the motion picture content such that the usage rule data is received by the playback apparatus 3 at least one of times.

The data carousel method refers to a method in which data is repeatedly transmitted at predetermined intervals. This ensures that a user can receive usage rule metadata of a motion picture content even when the user starts to view the motion picture content at some midpoint thereof.

Motion picture contents refer to digital data of a movie or the like represented, for example, in the MPEG (Moving Picture Experts Group) format. The motion picture content may include audio data, which can be played back in synchronization with the motion picture.

The usage rule metadata is right description metadata prescribing a limit within which a user can use the motion picture content. The usage rule metadata is described, for example, in XrML (extensible Rights Mark-up Language), which is an extension of XML (eXtensible Mark-up Language) and which provides a universal method for specifying rights and conditions associated with digital contents.

For example, the usage rule prescribed in the usage rule metadata includes the provision of whether extraction of a still image from a motion picture content is allowed, the provision of whether printing of a still image is allowed, the provision of whether copying of a still image is allowed, the provision of how many times printing or copying of a still image is allowed, the provision of a period during which secondary use of the motion picture content is allowed, and/or the provision of whether the right of secondary use is granted only to limited members. In addition to these provisions that limit the use of the motion picture content, information necessary in accounting, such as a fee for secondary use and an account to which the fee is to be charged, may also described in the usage rule metadata.

For example, it is prescribed that a user is allowed to extract a total of 10 frames of still images from a motion picture content A, which will be charged 500 yen.

As will be described in detail, the playback apparatus 3 generates user metadata in which a history of still image extraction is described and transmits it to the content server 2 via the network 4 so that the content server 2 can identify still images extracted by a user.

As described above, employment of usage rule metadata in which a usage rule is prescribed makes it possible for a user to extract a still image from a motion picture content within a limit determined by a copyright holder. The content provider can prescribe not only the limit within which extraction of still images is allowed but also the details of the manner in which to charge for extracted still images.

As for the playback apparatus 3, for example, a television receiver capable of receiving digital broadcasts or a combination of a television set and a set top box may be employed. The playback apparatus 3 is connected to an antenna for receiving a broadcast wave such that the playback apparatus 3 can receive a motion picture content and usage rule metadata transmitted from the content server 2.

The playback apparatus 3 analyzes the received usage rule metadata and controls the playback of the motion picture content according to the result of the analysis. More specifically, the playback apparatus 3 analyzes the usage rule metadata to check whether extraction of still images from the motion picture content is allowed. When a user issues a command to extract a still image, the playback apparatus 3 performs a still image extraction process if the usage rule metadata indicates that extraction is allowed. In a case in which extraction is not allowed, for example, the playback apparatus 3 generates an alarm without performing the still image extraction process.

The playback apparatus 3 is capable of extracting a still image from a motion picture content being broadcast. The playback apparatus 3 is also capable of recording a motion picture content being broadcast on a storage medium such as a hard disk or a DVD and extracting a still image from the recorded data. In the latter case, usage rule metadata is recorded together with the motion picture content to make it possible to perform secondary use of the recorded motion picture content.

The playback apparatus 3 can save an extracted still image in a secured form using a tamper-protected unit (that will be described in detail later). When the usage rule of prescribed in the usage rule metadata should also be applied to the extracted still image, the playback apparatus 3 also controls use of the saved still image according to the usage rule.

The playback apparatus 3 describes the history of use of motion picture contents by a user in user metadata. Information described in the user metadata includes information associated with playback of motion picture contents, such as identification information identifying a motion picture content played back by the user, the usage date/time, and information indicating performed operations (pause, fast forward, fast rewind, etc.), and also information associated with extraction of still images, such as identification information identifying a motion picture content from which a still image was extracted, the extraction date/time, and the extracted scene. Information associated with use of extracted still images may also be described in the user metadata.

The playback apparatus 3 transmits the user metadata, in which information necessary in charging for an extracted still image is described, to the content server 2 via a network 4. Based on the information described in the user metadata, the content server 2 performs an accounting process. Although in the present embodiment, only information necessary for accounting is described in user metadata transmitted to the content server 2, all information stored as user metadata in the playback apparatus 3 may be transmitted to the content server 2. This makes it possible to perform various kinds of statistical calculations, for example, to detect audience ratings.

As for the network 4, an IP network such as the Internet may be used. Communication is possible via the network 4 using a protocol such as TCP/IP (Transmission Control Protocol/Internet Protocol). A LAN (Local Area Network) or a WAN (Wide Area Network) may also be used as the network 4.

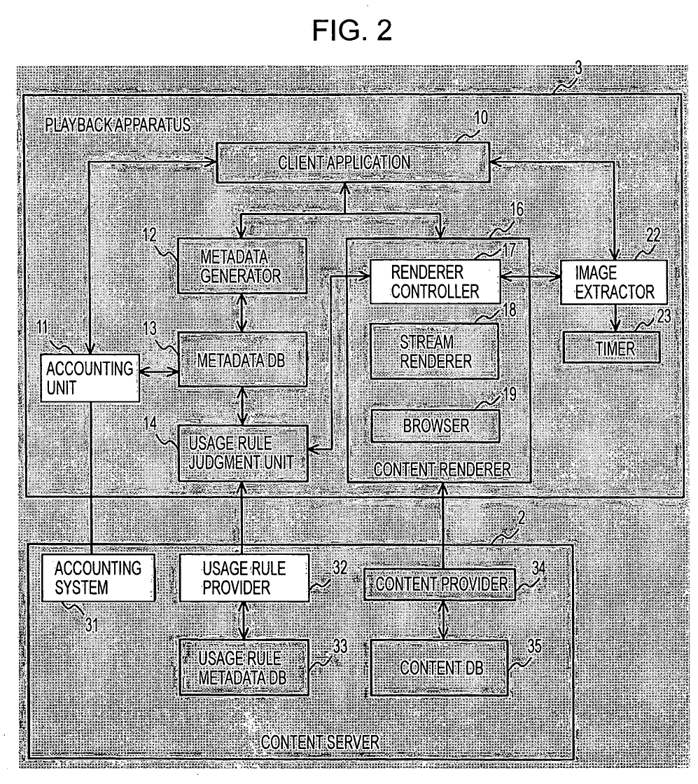

Now, referring to a block diagram shown in FIG. 2, the functional structures of the playback apparatus 3 and the content server 2 are described below. The playback apparatus 3 includes a client application unit 10, an accounting unit 11, a metadata generator 12, a metadata DB (database)13, a usage rule judgment unit 14, a content renderer 16, an image extractor 22, and a timer 23.

The usage rule judgment unit 14 acquires usage rule metadata from the content server 2, and analyzes the acquired usage rule metadata. Note that the usage rule metadata received from the content server 2 is in an encrypted form and is decrypted by the usage rule judgment unit 14. The usage rule judgment unit 14 serves as a usage rule acquisition unit. The resultant usage rule-obtained via the analysis performed by the usage rule judgment unit 14 is supplied to the renderer controller 17 and the client application unit 10.

The content renderer 16 includes a renderer controller 17, a stream renderer 18, and a browser 19 such that it serves as a functional block to acquire a motion picture content from the content server 2 and play it back. The content renderer 16 serves as content reception means for receiving a content and playback means for playing back the received content.

The renderer controller 17 controls the rendering operation such as extraction of a still image from a motion picture content, in accordance with the result of analysis performed by the usage rule judgment unit 14. More specifically, the renderer controller 17 checks the result of analysis performed by the usage rule judgment unit 14 and to determine whether extraction of a still image from a motion picture content is allowed. If extraction is allowed, the renderer controller 17 enables the image extractor 22 to extract a still image.

The playback apparatus 3 may store a user attribute indicating, for example, whether a user is registered in a particular service group or registered as a service member, and the renderer controller 17 may decide whether to enable the image extractor 22 to extract a still image, based on the user attribute and the usage rule metadata.

More specifically, it is prescribed in the usage metadata that any member of “Picture Club” has a right for extraction of still images. The renderer controller 17 judges whether the user is a member of “Picture Club” (the playback apparatus 3 has data indicating whether the user is a member of “Picture Club”) and enables the image extractor 22 to extract a still image when the user is a member of “Picture Club”.

The stream renderer 18 decodes the (encrypted) motion picture content received from the content server 2 and renders the motion picture content into a form that can be played back by the browser 19. The browser 19 displays the motion picture content rendered by the stream renderer 18 and generates a voice/sound associated with the motion picture content.

If a user issues a command to extract a particular scene as a still image, the image extractor 22 inquires of the renderer controller 17 whether extraction of the still image is allowed. If extraction is allowed, the image extractor 22 generates still image data of the specified scene from the motion picture content and stores the generated still image data. The still image data is generated, for example, in a format according to the JPEG (Joint Photographic Experts Group) standard. The extracted still image is corresponding information that can be played back by the content renderer 16, and the image extractor 22 serves as corresponding information acquisition means.

In other words, the image extractor 22 generates a still image content (corresponding information) representing a scene (particular part of the motion picture content) from the motion picture content. The still image data stored by the image extractor 22 can be displayed by the browser 19. In a case in which a usage rule is applied also to displaying of the still image, the renderer controller 17 controls displaying of the still image.

The image extractor 22 acquires, from the content renderer 16, identification information identifying a scene to be extracted and channel information identifying a broadcast channel, and acquires, from the timer 23, a time at which the still image was extracted. As scene identification information identifying a scene to be extracted as a still image, for example, time information (PTS (Presentation Time Stamp) of MPEG-2 TS) or frame information may be employed.

The metadata generator 12 generates user metadata in which an operation history indicating a history of operations performed by a user on the playback apparatus 3 is described. If a user extracts a still image from a motion picture content, content identification information identifying the motion picture content, scene identification information identifying the extracted still image, and a date/time when the still image is extracted are described in the user metadata. That is, the user metadata is history information in terms of acquisition of still images, and the metadata generator 12 serves as history information generation means.

In a case in which a fee for use (displaying, transferring, etc.) of the extracted still image is charged, user metadata in terms of charging may be generated. In this case, still image information including still image identification information identifying the still image, information indicating a date/time when the still image was used, and information indicating how the content was used is described in the user metadata.

The metadata DB 13 is a database in which user metadata generated by the metadata generator 12 and usage rule metadata acquired by the usage rule judgment unit 14 are stored. The user metadata stored in the metadata DB 13 may be used for accounting, and the usage rule metadata stored in the metadata DB 13 may be used as data indicating the usage rule in terms of playing back of the motion picture content.

The accounting unit 11 acquires the user metadata from the metadata DB 13 and transmits it to the content server 2. The accounting unit 11 serves as history information transmission means. Accounting is performed based on the user metadata transmitted from the accounting unit 11. In the present embodiment, payment is performed on a post-payment basis. That is, when a user extracts a still-image, a fee for the still image is charged, and the user pays later for it.

In accordance with an operation-performed by a user, the client application unit 10 provides the user with service using the motion picture content and/or the extracted still image, in cooperation with functional blocks such as the content renderer 16, the image extractor 22, the metadata generator 12, and/or the accounting unit 11.

The operation performed by the user includes, for example, selecting a command from a menu displayed on a screen or by operating a remote controller. More specifically, in accordance with an operation performed by a user, the client application unit 10 switches a channel, extracts a still image, displays an extracted still image, records a motion picture content, reads a recorded motion picture content, and/or plays back a recorded motion picture content. The client application unit 10 serves as designation acceptance means for accepting a command to designate a particular part (a scene to be extracted) of a played-back motion picture content.

The client application unit 10 controls the content renderer 16 to play back a motion picture content and display an extracted still image. More specifically, for example, the client application unit 10 accepts a channel switch command, plays back a motion picture content being broadcast, reads a motion picture content from a hard disk or DVD and plays it back, and/or reads a still image stored in the image extractor 22 and displays it.

If a user designates a scene, to be extracted as a still image, of a motion picture content being broadcast by, for example, pressing a “Still Image Acquisition” button disposed on the remote controller during playing-back of the content, the client application unit 10 accepts the designation. On the other hand, for a recorded motion picture content, the user can select a scene of the motion picture content when the motion picture content is being played back in accordance with an operation command, such as a “Start”, “Pause”, “Fast Forward”, “Fast Rewind”, “Slow”, or “Next Frame” command, issued by the user.

The client application unit 10 controls the image extractor 22 to extract a still image and receives still image information associated with the extracted still image from the image extractor 22. When usage metadata indicates that extraction of a still image is not allowed, the client application unit 10 notifies a user that extraction is not allowed, for example, by displaying a message on the browser 19.

The client application unit 10 transfers the still image information associated with the extracted still image to the metadata generator 12, and requests the metadata generator 12 to generate user metadata. When user metadata is generated in terms of processing other than still image extraction (for example, when user metadata in terms of usage of a still image or an operation history of a motion picture content is generated), the client application unit 10 transfers necessary information to the metadata generator 12 and requests it to generate user metadata.

The client application unit 10 sends a command to the accounting unit 11 to transmit user metadata to the content server 2 at predetermined intervals or each time an operation event occurs. In response to the command from the client application unit 10, the accounting unit 11 reads user metadata, to be transmitted, from the metadata DB 13 and transmits the user metadata to the content server 2.

As described above, the playback apparatus 3 receives a motion picture content and usage rule metadata, accepts designation of a particular part (a scene to be extracted as a still image) of the content played back by the content renderer 16, and performs processing associated with the designated particular part within the limit defined by the usage rule (as to whether extraction of still images is allowed) prescribed in the usage rule metadata. If extraction is allowed, the content renderer 16 acquires corresponding information (still image) that is capable of being played back.

The content server 2 includes an accounting system 31, a usage rule provider 32, a usage rule metadata DB (database) 33, a content provider 34, and a content DB (database) 35.

The content provider 34 reads a motion picture content from the content DB 35 and transmits it to the playback apparatus 3. The content provider 34 transmits motion picture contents via a plurality of channels. A program table is prepared for each channel. In accordance with the program tables, the content provider 34 reads motion picture contents from the content DB 35 and transmits them. The content provider 34 serves as content transmission means.

The content DB 35 is a database in which motion picture contents are stored. Identification information is attached to each motion picture content so that the content provider 34 can identify motion picture contents according to identification information.

The usage rule provider 32 reads usage rule metadata associated with a motion picture content being currently broadcast from the usage rule metadata DB 33 and transmits the read usage rule meta data to the playback apparatus 3. The transmission of the usage rule metadata from the usage rule provider 32 is performed, for example, by the data carousel method. The usage rule provider 32 serves as usage rule transmission means.

The usage rule metadata DB 33 is a database in which usage rule metadata associated with motion picture contents stored in the content DB 35 is stored. Identification information associated with each motion picture content is attached to corresponding usage rule metadata so that the usage rule provider 32 can search for usage rule metadata corresponding to a motion picture content being currently broadcast.

The accounting system 31 receives user metadata from the playback apparatus 3, and performs accounting based on the received user metadata. The user metadata is transmitted together with information identifying a user so that the accounting system 31 can accumulate accounting information for each user. The accounting system 31 serves as history information acquisition means and accounting means.

Personal information such as a name, age, and address of each user is registered together with information needed for payment, such as a credit card number or a bank account number are registered in advance in the contents server. The accounting system 31 collects fees for extracted still images from respective users at predetermined intervals (for example, once every month) based on the user information.

Although in the present embodiment, the fee for extraction of each still image is fixed, for example, at 50 yen, the fee may be determined flexibly depending on the situation. For example, the fee may be varied depending on the image quality such as the down-converted image resolution. More specifically, the free may be determined depending on image quality classes, such as a high quality class, a middle quality class, or a low quality class, of still images. The fee may also be determined depending on the value or purpose of each still image. For example, the fee may be set to be high for a still image of a popular star. On the other hand, commercial still images may be free.

More specifically, for example, fees may be set as follows. When a user A was watching a drama broadcast on ABC channel starting from 21:00 on Monday, the user A extracted a still image of a scene of his favorite popular actress. On the other hand, a user B extracted a still image of a scene of a new face when the user B was watching the same drama. A user C extracted a still image of a commercial of a car company which was broadcasted in a commercial time of the program. At the end of the drama, bills were sent to the respective users. As high as 500 yen was charged for the still image of the actress extracted by the user A because of high popularity of the actress, but only 100 yen was charged for the still image of the new face extracted by the user B. Nothing was charged to the user C for the still image of the commercial of the car company.

In the example described above, users can know the amounts of charges for still images when they receive bills from the content provider (via the network 4 or by mail). Alternatively, users may be notified of fees when they extract still images. In this case, for example, information identifying a scene specified by a user is sent to the accounting system 31 via the network 4. In response, the accounting system 31 returns information indicating the fee.

The accounting system 31 may perform data mining based on user metadata collected from the playback apparatus 3. The data mining refers to statistical analysis of data to extract useful information. Based on the statistical analysis, it is possible to determine which program or actor/actress has high popularity in terms of extraction of still images, and it is possible to determine fees based on popularity ranking.

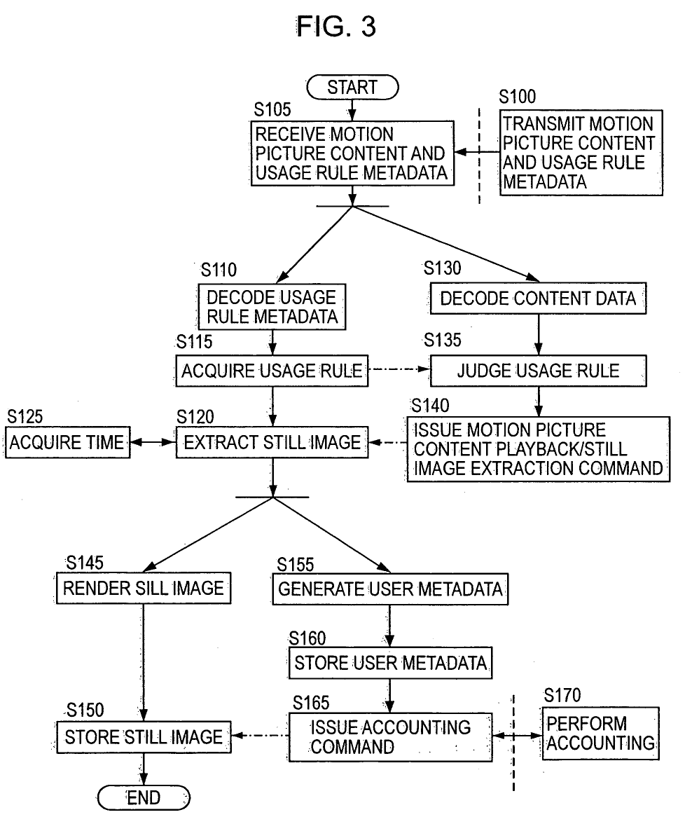

Now, referring to a flow chart shown in FIG. 3, a process of using still image extraction service on the playback apparatus 3 is described. First, the content server 2 transmits a motion picture content and usage rule metadata to the playback apparatus 3 via a broadcast wave (step 100).

The playback apparatus 3 receives the motion picture content and usage rule metadata transmitted from the content server 2 (step 105). Note that the usage rule metadata is transmitted repeatedly, and it is sufficient to receive one of data transmitted repeatedly.

When the usage rule metadata is received by the playback apparatus 3, it is decoded by the usage rule judgment unit 14 (step 110). The usage rule judgment unit 0.14 analyzes the decoded usage rule metadata, and acquires a usage rule (in terms of allowance of still image extraction) imposed on the motion picture content being currently received. The usage rule is notified to the renderer controller 17 (step 115). In this example, it is assumed that extraction of still images is allowed.

On the other hand, the motion picture content received by the playback apparatus 3 is decoded by the stream renderer 18 (step 130). The stream renderer 18 then renders the decoded motion picture content into a form that can be displayed on the browser 19.

The renderer controller 17 examines the usage rule received from the usage rule judgment unit 14, and controls the rendering operation so that the decoded motion picture content is allowed to be used within the limit of the usage rule (step 135).

Under the control of the renderer controller 17, the stream renderer 18 plays back the motion picture content such that the moving image is displayed on the browser 19 and an associated voice/sound is generated. When the stream renderer 18 is playing back the motion picture content, the client application unit 10 is standing by to handle a still image extraction command issued by the user. If the client application unit 10 receives a still image extraction command from the user, the client application unit 10 sends a command to the content renderer 16 and the image extractor 22 to extract a still image (step 140).

In response to receiving the still image extraction command from the client application unit 10, the renderer controller 17 examines the usage rule metadata to check whether extraction of the still image is allowed. If extraction of the still image is allowed, the renderer controller 17 enables the image extractor 22 to extract the still image, but otherwise the renderer controller 17 disables the image extractor 22 to extract the still image. In the present example, it is assumed that extraction of the still image is allowed.

When the image extractor 22 receives the still image extraction command from the client application unit 10, if the renderer controller 17 enables the image extractor 22 to extract the still image, the image extractor 22 extracts the still image from the motion picture content (step 120). In the still image extraction process, the image extractor 22 acquires from the timer 23 a time at which the still image was extracted (step 125), and transfers still image information including information identifying the scene and identification information identifying the motion picture content to the client application unit 10.

The image extractor 22 renders the extracted still image (step 145), and stores the resultant still image (step 150). The client application unit 10 transfers the still image information to the metadata generator 12 and requests the metadata generator 12 to generate user metadata. If the metadata generator 12 receives the still image information from the client application unit 10, the metadata generator 12 generates user metadata information based on the received still image information (step 155). The generated user metadata is stored in the metadata DB 13 (step 160).

The client application unit 10 sends a command to the accounting unit 11 to transmit the user metadata at predetermined intervals or each time an operation event occurs. In response to receiving the command, the accounting unit 11 retrieves user metadata, to be transmitted, from the metadata DB 13 and transmits the retrieved user metadata to the content server 2. Based on the transmitted user metadata, accounting is performed (step 165).

In the content server 2, the accounting system 31 performs an accounting process based on the user metadata received from the accounting unit 11 (step 170), When accounting is completed, a notice of the completion of accounting is transmitted to the accounting unit 11. The accounting unit 11 transfers the received notice of the completion of accounting to the client application unit 10. The client application unit 10 notifies the user of the completion of the accounting process, for example, by displaying a message on the browser 19.

Via the process described above, a user can extract a still image of a desired scene from a motion picture content and can request settlement of the fee for the extracted still image. The extracted still image can be stored in the image extractor 22 and can be displayed on the browser 19. This makes it possible to achieve user's convenience while protecting the copyright of the content provider.

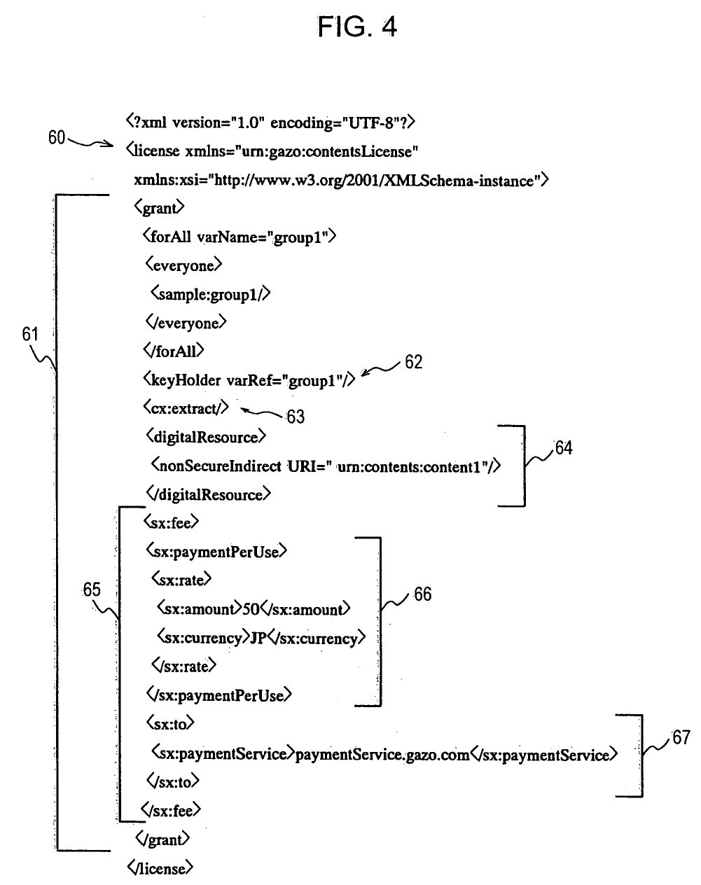

Now, the usage rule metadata is described in further detail below. FIG. 4 is a diagram showing an example of usage rule metadata. In the present embodiment, the usage rule metadata is described in the XrML language (other metadata described below is also described in the XrML language). In the example shown in FIG. 4, the usage rule metadata indicates that any dedicated terminal (TV receiver, set top box, etc.) registered as a terminal of a contract class of group 1 is allowed to extract a still image from a motion picture content (urn:contents:content1) and also indicates that 50 yen is charged each time a still image is extracted and payment is performed later for the charged amount. There are various contract classes that are different in service and/or fee, and a user can choose one of classes when a user registration is made.

Data elements of the usage rule metadata are described below.

In line 60 starting with <license, a root of the usage rule metadata is described. In a part enclosed between <license . . . > and </license>, information associated with license is described. In a part 61 enclosed between <grant> and </grant>, what is granted is described.

“group1”/ in line 62 indicates a user whom the license is granted to. In this example, the license is granted to a user who is registered as being of the contract class of “group1”. In this case, the renderer controller 17 (FIG. 2) examines the user attribute stored in the playback apparatus 3 to check whether the contract class of the user is “group1”. If the user attribute indicates that the contract class of the user is “group1”, the renderer controller 17 allows a still image to be extracted.

<cx:extract/> in line 63 indicates that extraction of still images is allowed. When copying is allowed, “copy” is described herein instead of “extract”.

In a part 64 enclosed between <digitalResource> and </digitalResource>, identification information is described to identify a motion picture content from which extraction of a still image is allowed. In the example shown in FIG. 4, a motion picture content (urn:contents:content1) is specified.

In a part 65 enclosed between <sx:fee> and </sx:fee>, information associated with charging is described. In the part 65, a part 66 enclosed between <sx:paymentPerUse> and </sx:paymentPerUse> prescribes payment. <sx:amount>50</sx:amount> prescribes the fee (50 in this specific example), and <sx:currency> JP</sx:currency> prescribes currency (Japanese yen in this specific example). In this specific example, it is prescribed herein that 50 yen should be charged for each still image.

A part 67 enclosed between <sx:to > and </sx:to > specifies an accounting server (the accounting server 31 in the present embodiment). In the example shown in FIG. 4, “paymentService.gazo.com” is specified as the accounting server.

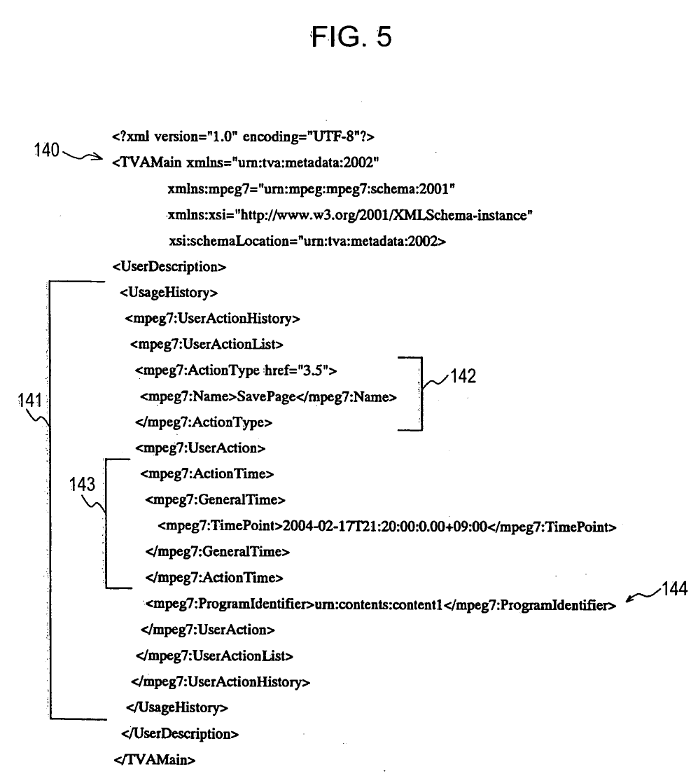

Now, the user metadata is described in further detail below. FIG. 5 is a diagram showing an example of user metadata. This user metadata is generated by the metadata generator 12, when a still image is extracted from a motion picture content (urn:gazo:content1). The user metadata includes information indicating a handled content (urn:gazo:content1) and operation information (SavePage) acquired by the content renderer 16, and also includes information indicating the operation time (at 21:20:00 on Feb. 17, 2004) acquired from the timer 23.

Data elements of the user metadata are described below. In line 140 starting with <TVAMain, a root of the user metadata is described. In a part 141 enclosed between <UsageHistory> and </UsageHistory>, a usage history of a user is described.

In a part 142 enclosed between “3.5” and </mpeg7:ActionType>, information associated with an operation selected by the user is described. In this example, “SavePage” described herein indicates that a still image has been saved.

In a part 143 enclosed between <mpeg7:ActionTime> and </mpeg7:ActionTime>, the time at which the operation (saving of the still image) was performed by the user is described. In this example, “2004-02-17T21:20:00:0.00+09:00” described herein indicates that the operation was performed at 21:20 on Feb. 17, 2004.

In a part 144 enclosed between <mpeg7:ProgramIdentifier> and </mpeg7:ProgramIdentifier>, identification information is described to identify a motion picture content from which a still image has been extracted. In this example, the identification information indicates that a still image has been extracted from a motion picture content identified by “urn:contents:content1”.

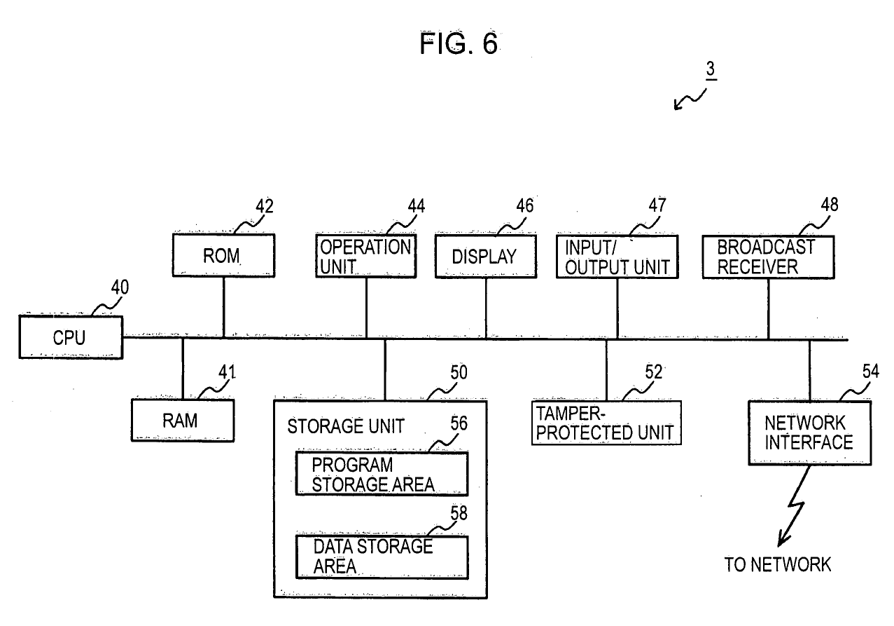

Now, the hardware configuration of the playback apparatus 3 is described with reference to FIG. 6. In the playback apparatus 3, a ROM (Read Only Memory) 42, a RAM (Random Access Memory) 41, an operation unit 44, a display 46, an input/output unit 47, a broadcast receiver 48, a storage unit 50, a tamper-protected unit 52, and a network interface 54 are connected to a CPU (Central Processing Unit) 40 via a bus line. The CPU 40 loads a program from the ROM 42, the storage unit 50, or other storage device and executes the loaded program. In the present embodiment, the CPU 40 executes a playback program stored in the storage unit 50 thereby implementing functions of the playback apparatus 3.

The ROM 42 is a read-only nonvolatile memory in which various programs, data, and parameters used by the CPU 40 to perform fundamental functions. The program stored in the ROM 42 is executed, for example, when the operation of the playback apparatus 3 is started. The RAM 41 is a read/write memory used as a working memory by the CPU 40 in execution of the playback program.

The operation unit 44 includes an operation terminal such as a control panel or a remote controller functioning as a unit for accepting an operation command input by a user to control the operation of the playback apparatus 3. This capability makes it possible for the client application unit 10 (FIG. 2) to receive various kinds of operation commands from the user.

The operation unit 44 has a capability that allows a user to input characters, numerals, and/or symbols. The operation unit 44 includes function buttons such as a “Play” button and a “Pause” button for controlling the playback operation of a motion picture content. The operation can also be controlled using a GUI (Graphical User Interface) by selecting an icon from a menu displayed on the display 46.

The user can acquire a still image by operating the operation unit 44 (for example, first pressing the “Pause” button to pause playback of a motion picture content and then pressing an “Image Save” button). The user can also use the operation unit 44 to access the content server 2 to make a user registration or a member registration for “Picture Club” or the like.

The display 46 includes a display device such as a plasma display, a liquid crystal display, or a CRT display, and serves to display a played-back motion picture content or still image. The display 46 also includes a loudspeaker to output a played-back voice/sound associated with a motion picture content.

The input/output interface 47 is connected to external devices such as a storage-medium drive for driving a storage medium such as a DVD disk and a printer such that inputting/outputting of data is performed via the input/output interface 47. When a movie content or the like stored on a DVD disk is played back, the movie content is read from the DVD disk via the input/output interface 47.

The broadcast receiver 48 includes a tuner and other parts and serves to receive a broadcast wave. The broadcast receiver 48 is connected to an antenna (not shown). The broadcast receiver 48 receives a broadcast wave via the antenna and converts it into digital data in a form that can be processed by the CPU 40. The playback apparatus 3 can acquire a motion picture content and associated usage rule metadata by using the broadcast receiver 48.

The network interface 54 is an interface for connection with a network 4. For example, a modem is used as the network interface 54. The playback apparatus 3 can communicate with the content server 2 via the network interface 54 to request it to perform, for example, accounting.

For example, a tamper protection chip is used as the tamper-protected unit 52. The tamper-protected unit 52 includes a functional block for encryption and decryption and is formed such that the internal structure cannot be easily analyzed from the outside. In the present embodiment, the tamper-protected unit 52 includes the metadata generator 12, the metadata DB 13, the usage rule judgment unit 14, the content renderer 16, image extractor 22, and the timer 23, shown in FIG. 2. The tamper-protected unit 52 may be realized by software such that information is handled in an encrypted form.

Still image data generated by the image extractor 22 is stored in the tamper-protected unit 52 such that user metadata is prevented from being tampered, the generated still image is prevented from illegally copied, the encryption algorithm is prevented from being analyzed, and other rights of the content provider is protected.

The storage unit 50 is a high-capacity storage device such as a hard disk accessible by the CPU 40 to store/read information. The storage unit 50 has a program storage area 56 for storing programs and a data storage area 58 for storing data.

In the program storage area 56, programs such as an OS (Operating System) and the playback program are installed. The OS is a program that provides fundamental functions necessary to input/output a file and control the operation of the playback apparatus 3.

The playback program is a computer program executed by the CPU 40 to achieve functions of playing back a motion picture content and generating still image data. That is, the playback program is software that allows the client application unit 10, the accounting unit 11, and other functional parts to be implemented on the CPU 40. These functional parts implemented by software operate in cooperation with the functional parts such as the metadata generator 12 and the content renderer 16 formed in the tamper-protected unit 52.

The data storage area 58 can also be used to store (record) a motion picture content acquired from the content server 2. The information described above is stored in an encrypted form and is decrypted by the stream renderer 18 or the usage rule judgment unit 14 when playback is performed. A user attribute indicating, for example, that a user is a member of “Picture Club” is also stored in the data storage area 58.

Note that the embodiment described above can be modified in various fashions. For example, although in the present embodiment, usage rule metadata is transmitted together with a motion picture content on a broadcast wave to the playback apparatus 3, usage rule metadata may be transmitted to the playback apparatus 3 via the network 4 separately from a motion picture content.

In this case, the usage rule server for transmitting usage rule metadata receives identification information identifying a motion picture content from the playback apparatus 3 or the content server 2 (using identification information reception means) and retrieves corresponding usage rule metadata from the database. If the corresponding usage rule metadata is retrieved, the usage rule server transmits it (using usage rule transmission means) to the playback apparatus 3.

In the case in which a motion picture content and usage rule metadata are transmitted separately, the playback apparatus 3 may acquire the usage rule metadata in advance before the motion picture content is broadcast, or may download the usage rule metadata from the content server 2 when the motion picture content is received.

This method is suitable when a broadcast motion picture content is first stored in a hard disk or the like disposed in the playback apparatus 3 and then played back by reading it from hard disk. In the case in which usage rule metadata and a motion picture content are transmitted separately, identification information (content ID) identifying the motion picture content is embedded in the usage rule metadata so that the playback apparatus 3 can determine the correspondence between them. When the playback apparatus 3 receives the motion picture content, the playback apparatus 3 examines usage rule metadata that have already been received to detect usage rule metadata corresponding to the received motion picture content.

Usage rule metadata may be embedded in a corresponding motion picture content (for example, in a header or the like) such that the playback apparatus 3 can extract the usage rule metadata. This method is suitable when the motion picture content is allowed to be downloaded to purchase.

Although in the present embodiment, a still image is extracted from a motion picture content, a still image content may be transmitted to the playback apparatus 3 from the content server 2 via the network 4. In the case in which still image contents are transmitted from the content server 2, it is possible to provide still images with a higher resolution than can be obtained for still images extracted from motion picture contents. In this case, the still image transmitted from the content server 2 is corresponding information.

In this case, to acquire a still image, the playback apparatus 3 transmits (via the particular part designation information transmission means) user metadata including scene identification information identifying a scene of a motion picture content to the content server 2 via the network 4. If the content server 2 receives (via the particular part designation information reception means) the user metadata, the content server 2 transmits (using the corresponding information transmission means) the still image content of the specified sconce to the playback apparatus 3 via the network 4. In this case, settlement processing may be performed in advance of transmission of still image contents to ensure that fees for still image contents are collected.

Alternatively, when a motion picture content is transmitted, still image contents may also be transmitted to the playback apparatus 3 by using a data transmission band of a broadcast wave. In this case, still image contents transmitted together with a motion picture content serves as related information related to the motion picture content, and the content server 2 has related information transmission means. This allows a user to preview still images on the browser 19 before purchasing a still image.

In the case in which still image data is transmitted at the same time as a motion picture content, the still image data may be transmitted in an encrypted form and the playback apparatus 3 may decrypt the received still image data. In this case, to decrypt the still image data, the playback apparatus 3 requests (using the decryption key request means) the content server 2 to provide a decryption key. If the content server 2 receives the request (via the request acceptance means), the content server 2 transmits a decryption key to the playback apparatus 3 (via decryption key transmission means). The playback apparatus 3 receives this decryption key (by using decryption key reception means) and decrypts the still image data. In this case, the content server 2 may transmit the decryption after accounting is completed. Decryption keys may be created individually for respective still image data or a single decryption key for common use for all still image data may be created.

In the case in which a user acquires still image data by sending a request for processing to the content server 2 as in the case in which a decryption key is provided from the content server 2 to the user in response to the request from the user, accounting may be performed based on the request. In this case, accounting can be performed without receiving user metadata from the playback apparatus 3.

Some more modifications to the embodiment are further described below.

First Modification

In this modification, any user who has been registered as a member of a license group “Picture Club” is allowed to freely extract still images from particular motion picture contents specified by “Picture Club”. In the embodiment described above, settlement is performed after a still image is extracted. In this modification, users who have already been registered as members and have paid a membership fee may be allowed to freely extract still images from motion picture contents specified by “Picture Club”.

This service may be provided, for example, based on membership registration license metadata indicating that a user is a member of “Picture Club” and content license metadata indicating that a motion picture content is a content that can receive the service associated with “Picture Club”.

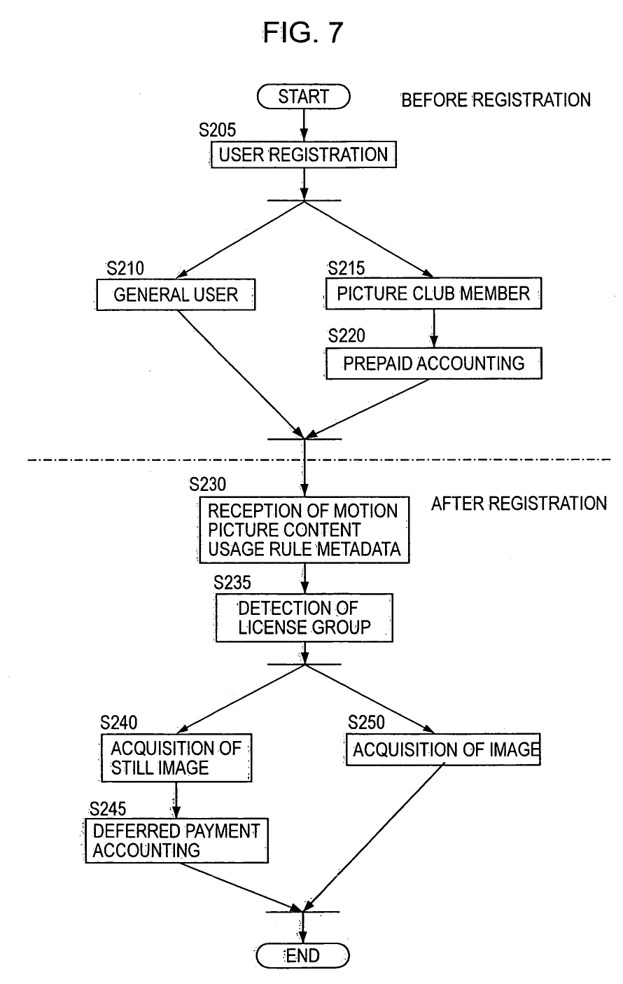

FIG. 7 is a flow chart illustrating a process in which a member of “Picture Club” and a non-member acquire still image data. This process starts when a user accesses the content server 2 via the network 4 from the playback apparatus 3. In this process, the playback apparatus 3 serves as a terminal for communicating with the content server 2 via the network 4.

First, before making a registration for membership of “Picture Club”, a user accesses a user registration site of the content server 2 from the playback apparatus 3 and transmits a request for a user registration (step 205). The user can choose whether to become a member of “Picture-Club”. When the user decides not to become a member, the user is registered as an ordinary user (step 210).

In the registration, personal information such as a bank account number or a credit card number, an address, a telephone number, and other necessary personal information are registered. When a user is registered as an ordinary user, a user ID is assigned to him/her. For ordinary users, as described above in the embodiment, fees for still images are charged when still images are extracted and payment is performed later.

When the user decides to become a member of “Picture Club”, a membership registration in addition to an ordinary user registration is performed (step 215). In the case in which the user has become a member of “Picture Club”, the content server 2 charges the account of the user for prepayment for the membership fee of “Picture Club” (step 220). Thus, necessary pre-processing is completed.

Once the user is registered as an ordinary user or a member of “Picture Club”, the user can receive a motion picture content and usage rule metadata from the content server 2 (step 230), by using the playback apparatus 3. If a motion picture content and usage rule metadata are received, the playback apparatus 3 checks the membership registration license to determine whether the user is a member of “Picture Club”. The playback apparatus 3 then checks the content license to determine whether the received motion picture content is a content that can receive service associated with “Picture Club” (step 235).

When the user is an ordinary user or when the received motion picture content is a content that cannot receive service associated with “Picture Club”, if a still image is acquired (step 240), accounting for post-payment is performed (step 245). In the case in which the user is a member of “Picture Club” and the received motion picture content is a content that can receive service associated with “Picture Club”, no accounting is performed when a still image is acquired (step 250).

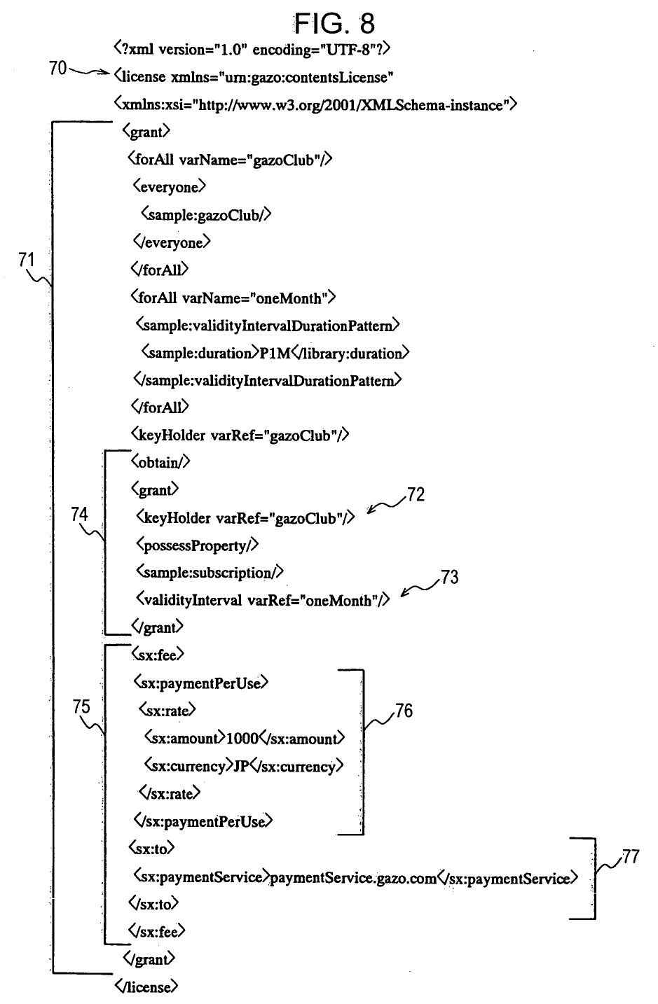

FIG. 8 shows an example of a membership registration license. In this example, the membership registration license indicates that a user, who has a dedicated terminal and who is a member of “Picture Club” (gazoclub) and has prepaid 1000 yen per month, is allowed to extract a still image from any of motion picture contents specified for use by members of “Picture Club” in a specified period (one month).

Data elements of the membership registration license are described below. In line 70 starting with <license, a root of the usage rule metadata is described. In a part 71 enclosed between <grant> and </grant>, information associated with rights is described.

In a part 74 enclosed between <obtain/><grant> and </grant>, rights granted to a user are described. In line 72 in the part 74, “gazoClub”/indicates that the right as a member of “Picture Club” is granted.

In line 73, “oneMonth”/indicates that extraction of still images is allowed for one month. In a part 75 enclosed between <sx:fee> and </sx:fee>, information associated accounting is described.

In the part 75, a fee is prescribed in a part 76 enclosed between <sx:paymentPerUse> and </sx:paymentPerUse>. More specifically, the amount of fee is prescribed by <sx:amount>1000</sx:amount> (the amount of fee is 1000, in this specific example), and currency is prescribed by <sx:currency> JP</sx:currency> (Japanese yen in this example) That is, 1000 yen is charged for use per month.

In a part 77 enclosed between <sx:to > and </sx:to >, information identifying an accounting server is described (the accounting system 31 is specified in the embodiment). In this specific example, “paymentService.gazo.com” is specified as the accounting server.

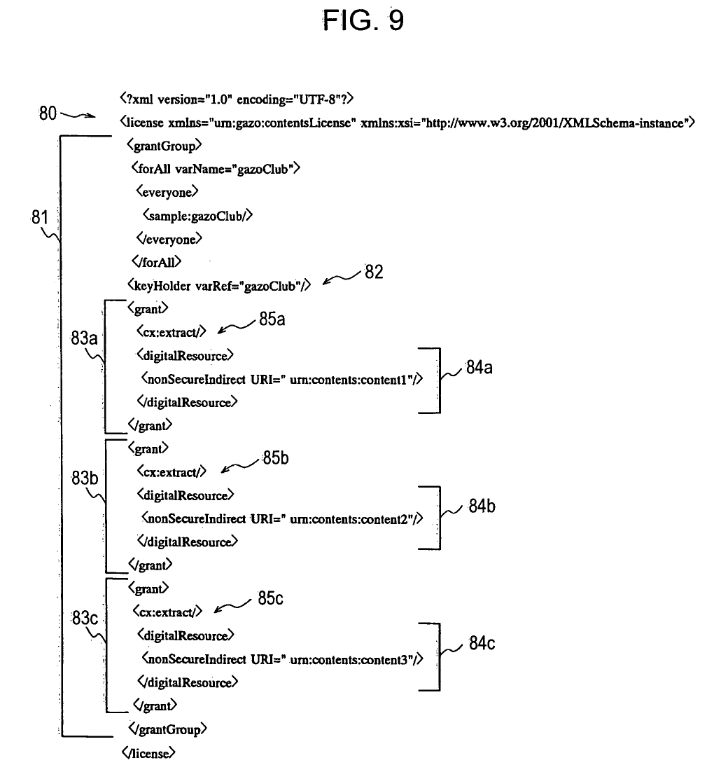

FIG. 9 shows an example of a content license in which provision is described as to a motion picture content that can receive service associated with “Picture Club”. The renderer controller 17 checks this content license to determine whether a received motion picture content is registered in the content license. If the motion picture content is registered, the renderer controller 17 allows a still image to be extracted from the motion picture content.

Data elements of the content license are described below. In line 80 starting with <license, a root of the usage rule metadata is described. In a part 81 enclosed between <grantGroup> and </grantGroup>, rights are described in parts 83a to 83c for respective groups. Motion picture contents specified in the part 81 can receive service associated with “Picture Club”. “gazoClub”/in line 82 indicates a user whom the license is granted to. In this example, it is indicated that any member of “Picture Club” holds the right.

In a part 83a enclosed between <grant> and </grant>, rights granted to a motion picture content specified herein are described. <cx:extract/> in line 85a in the part 83a indicates that extraction of still images is allowed. In a part 84a enclosed between <digitalResource> and </digitalResource>, identification information is described to identify a motion picture content from which extraction of a still image is allowed. In the example shown in FIG. 9, a motion picture content (urn:contents:content1) is specified.

Parts 83b and 83c are described in a similar manner. That is, line 85b in the part 83b indicates that extraction of still images is allowed, and a part 84b specifies a motion picture content (urn:contents:content2) from which extraction of still images is allowed. Line 85c in the part 83c indicates that extraction of still images is allowed, and a part 84c specifies a motion picture content (urn:contents:content3) from which extraction of still images is allowed.

As described above, a member who has the membership registration license shown in FIG. 8 is allowed to extract a still image from motion picture contents specified in parts 83a to 83c of the content license shown in FIG. 9.

Membership registration licenses and content licenses may be distributed in many ways. For example, a membership registration license and a content license are transmitted to the playback apparatus 3 together with a motion picture content and usage rule metadata. If the playback apparatus 3 judges that a user is a member of “Picture Club” based on the received membership registration license, the playback apparatus 3 operates so as to allow the user to receive service associated with “Picture Club”. In this case, information indicating the user is a member of “Picture Club” is stored beforehand in the playback apparatus 3.

Alternatively, a membership registration license and a content license may be sent beforehand to the playback apparatus 3 of each member of “Picture Club”, so that when a motion picture content is received, it is possible to judge from the content license whether the received motion picture content is a content that can receive service associated with “Picture Club”.

Second Modification

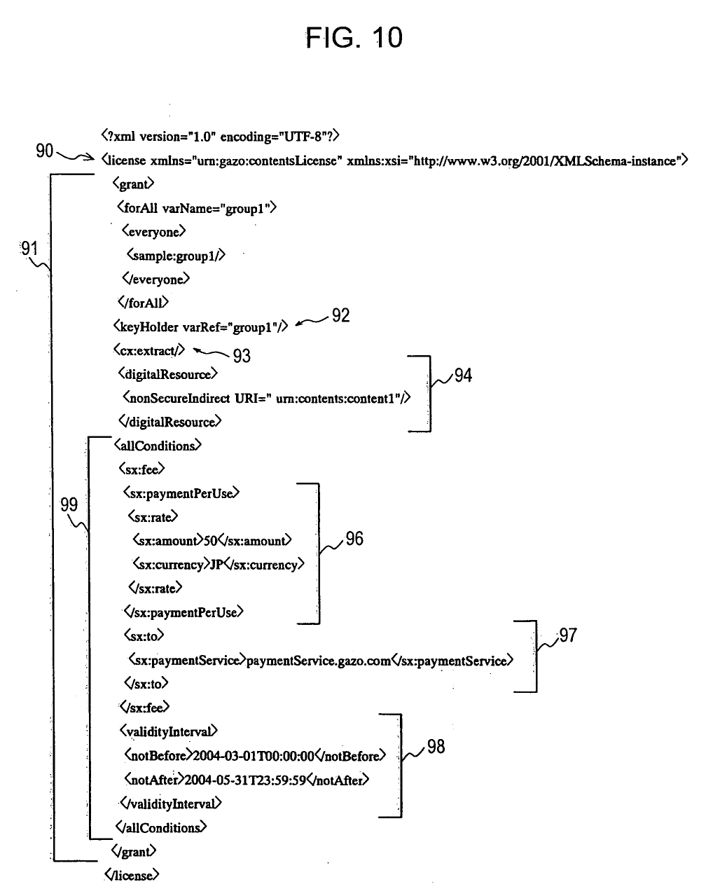

In this second modification, extraction of still images from motion picture contents is allowed in a limited period specified by usage rule metadata. FIG. 10 shows an example of usage rule metadata. In the example shown in FIG. 10, still image extraction service is provided during a period from Mar. 1, 2004 to May 31, 2004.

Data elements of the usage rule metadata are described below. In line 90 starting with <license, a root of the usage rule metadata is described. In a part 91 enclosed between <grant> and </grant>, what is granted is described.

“group1”/in line 92 indicates a user whom the license is granted to. In this example, the license is granted to a user who is registered as being of the contract class of “group1”. <cx:extract/> in line 93 indicates that extraction of still images is allowed.

In a part 94 enclosed between <digitalResource> and </digitalResource>, identification information is described to identify a motion picture content from which extraction of a still image is allowed. In the example shown in FIG. 10, a motion picture content (urn:contents:content1) is specified.

In a part 99 enclosed between <allConditions> and </allConditions>, fees (in a part 96) and allowed usage period (in a part 98) are described for respective groups. In a part 96 enclosed between <sx:paymentPerUse> and </sx:paymentPerUse>, information associated with payment is described. In this specific example, it is prescribed that 50 yen should be charged for each still image. In a part 97 enclosed between <sx:to > and </sx:to >, an accounting server is specified. In this specific example, “paymentService.gazo.com” is specified as the accounting server.

In a part 98 enclosed between <validityInterval> and </validityInterval>, a period during which extraction of still images is allowed is described. A part enclosed between <notBefore> and </notBefore> specifies a start date/time of the usage period. In this example, “12004-03-01T00:00:00” indicates that the start date/time is 0 o'clock on Mar. 1, 2004. A portion enclosed between <notAfter> and </notAfter> specifies an expiration date/time of the usage period. In this example, “2004-05-31T23:59:59” indicates that the expiration date/time is 23:59:59 on May 31, 2004.

When a command to extract a still image is issued by a user, the renderer controller 17 (FIG. 2) detects the current time from the timer 23 and checks whether it is within the allowed usage period prescribed in the part 98. If it is within the allowed usage period, the renderer controller 17 enables the image extractor 22:to extract the still image.

Third Modification

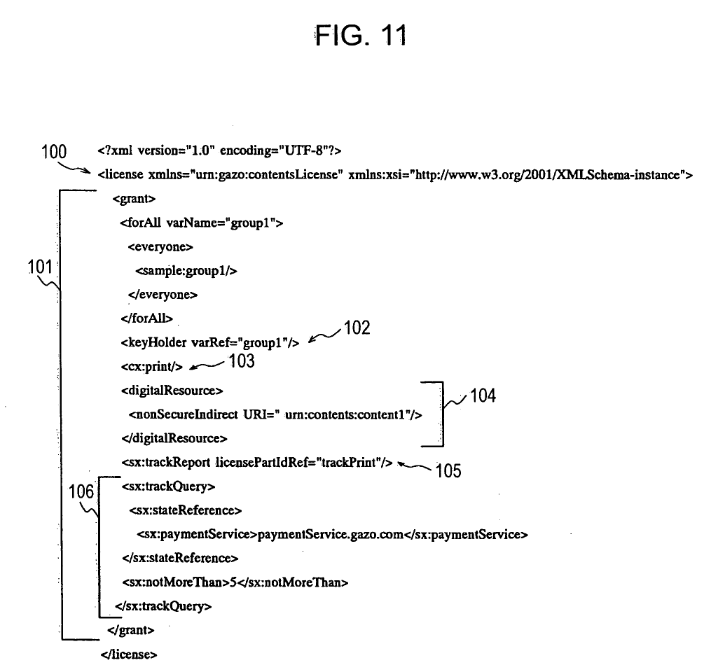

In this modification, the upper limit of the number of times printing is allowed is prescribed in the usage rule metadata, and printing service for a scene of a motion picture content is provided within the prescribed limit. FIG. 11 is a diagram showing an example of usage rule metadata in which print service is prescribed.

In line 100 starting with <license, a root of the usage rule metadata is described. In a part 101 enclosed between <grant> and </grant>, what is granted is described.

“group1”/ in line 102 indicates a user whom the license is granted to. In this example, the license is granted to a user who is registered as being of the contract class of “group1”. <cx:print/> in line 103 indicates that printing of still images is allowed.

In a part 104 enclosed between <digitalResource> and </digitalResource>, identification information is described to identify a motion picture content from which printing of still images is allowed. In the example shown in FIG. 9, a motion picture content (urn:contents:content1) is specified.

In line 105, “trackPrint”/ indicates that print service is tracked and the tracked result is reported to the accounting server (accounting system 31). The renderer controller 17 tracks the number of times of printing permits printing when the current value of the number of times is lower than the upper limit.

In a part 106 enclosed between <sx:trackQuery> and </sx:trackQuery>, the upper limit of the number of times printing is allowed is prescribed. In a part enclosed between <sx:paymentService> and </sx:paymentService>, an accounting server is specified. <sx:notMoreThan>5</sx:notMoreThan> indicates that 5 is the upper limit of the number of times printing is allowed to be performed. Although in the example shown in FIG. 11, the fee for each printing is not prescribed in the usage rule metadata and thus no fee is charged for printing, a fee may be prescribed in the usage rule metadata.

Fourth Modification

In this fourth modification, a user is allowed to provide extracted still image data to another user. In this exchange service among users, the playback apparatus 3 of a user who is a provider of a still image transmits usage rule metadata together with the still image to a playback apparatus of a user who is a receiver of the still image so that accounting for the still image is performed by the playback apparatus of the receiver. The still image data is transmitted to the playback apparatus 3 of the receiver via the network 4.

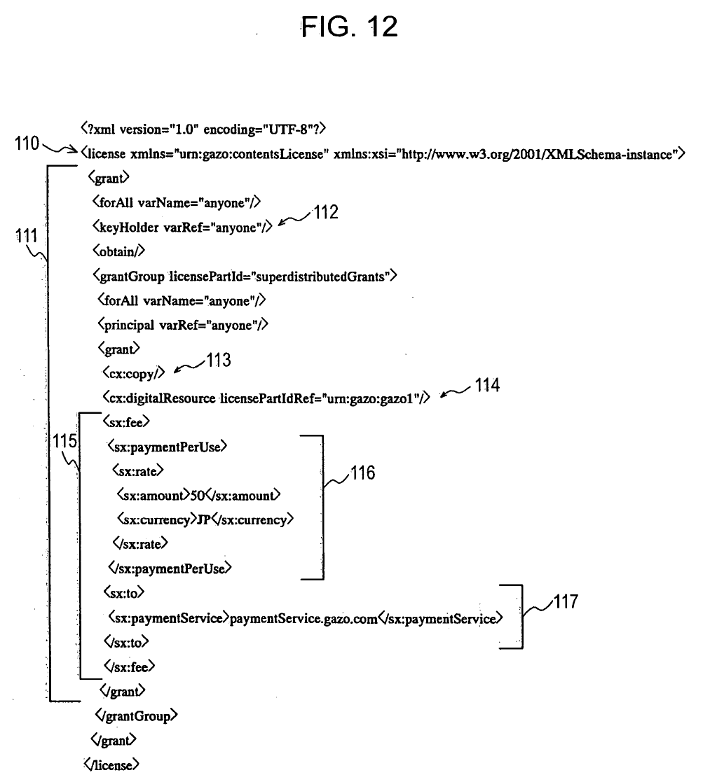

In the example shown in FIG. 12, the usage rule metadata indicates that a copy of a still image (urn:gazo:gazo1) acquired in sample 1 can be transferred to another user. The user who has receives the still image should pay 50 yen per image to the content provider (paymentService.gazo.com).

Data elements of the usage rule metadata are described below. In line 110 starting with <license, a root of the usage rule metadata is described. In a part 111 enclosed between <grant> and </grant>, what is granted is described.

In line 112, “anyone”/ indicates a user the right is granted to. In this example, the right is granted to “anyone”, and thus users who can obtain a still image are not limited to particular users. <cx:copy/> in line 113 indicates that copying of still images is allowed.

In line 114, “urn:gazo:gazo1”/ specifies a motion picture content from which extraction of a still image is allowed. In the example shown in FIG. 12, a motion picture content (urn:gazo:gazo1) is specified.

In a part 115 enclosed between <sx:fee> and </sx:fee>, information associated accounting is described. In the part 115, a fee is prescribed in a part 116 enclosed between <sx:paymentPerUse> and </sx:paymentPerUse>. In this specific example, it is prescribed herein that 50 yen should be charged for copying of each still image.

A part 117 enclosed between <sx:to > and </sx:to > specifies an accounting server (the accounting server 31). In this specific example, “paymentService.gazo.com” is specified as the accounting server.

In this modification, the playback apparatus 3 includes correspondence information usage rule acquisition means for acquiring correspondence information usage rule (usage rule metadata) in which a usage rule of the acquired still image (correspondence information) is prescribed, and also includes correspondence information transmission means for transmitting the correspondence information usage rule together with the still image to a playback apparatus of another user.

Although in the embodiment and modifications described above, a motion picture content is subjected to secondary use (more specifically, a still image is extracted from the motion picture content), other types of contents may also be subjected to secondary use.

Fifth Modification

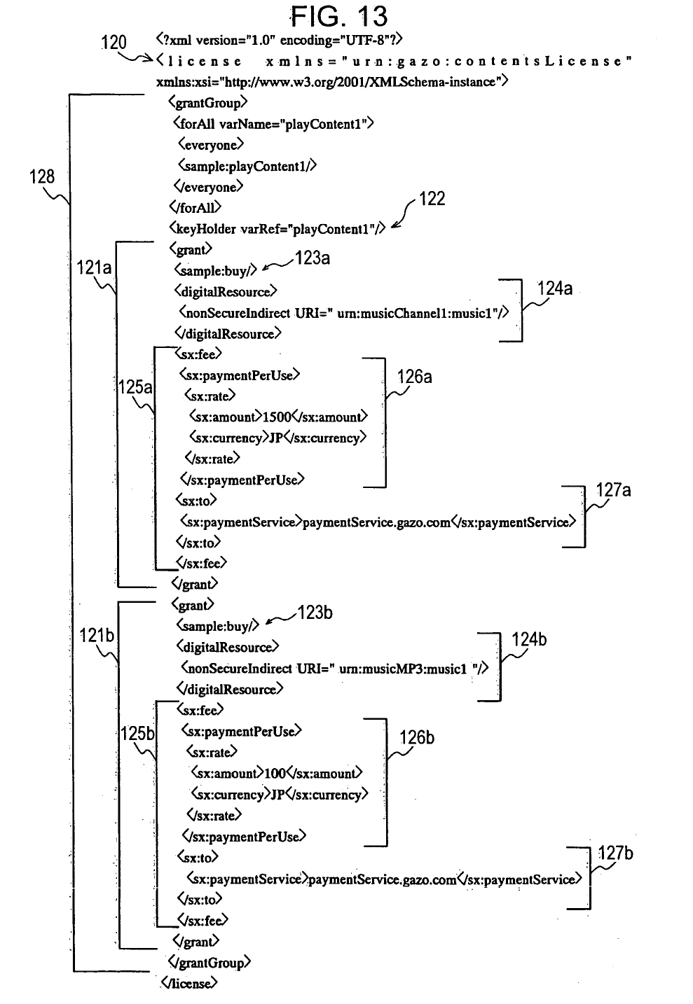

In this fifth modification, a user is allowed to purchase a music content associated with a musical program. FIG. 13 is a diagram showing an example of usage rule metadata in which music content purchase service is prescribed.

In the example shown in FIG. 13, the usage rule metadata indicates that a user, who has a dedicated terminal of registered in “metadata acquisition contract class (group1) and who has viewed/listened to a music program (urn:musicChannel:musicl), is allowed to purchase a related music CD album data (urn:musicCD:music1) at 1,500 yen and MP3 data (urn:musicMP3:music1) at 100 yen, and also indicates that payment is performed on a post-payment basis.

In the usage rule metadata described above, CD denotes a compact disc and MP3 denotes MPEG-1 Audio Layer-3. If a user purchases audio CD album data or MP3 data, the user is allowed to download a corresponding music content from the content server 2 to the playback apparatus 3. In this modification, the audio CD album data or the MP3 data is correspondence information.

Data elements of the usage rule metadata are described below. In line 120 starting with <license, a root of the usage rule metadata is described. In a part 128 enclosed between <grantGroup> and </grantGroup>, rights are described for respective groups (in parts 121a and 121b).

In line 122, “playContent1”/indicates a user the license is granted to. In this example, the license is granted to a user who is registered as being of the contract class of “playContent1”.

In a part 121a enclosed between <grant> and </grant>, rights associated with purchasing of.CD are described. In line 123a, <sample:buy/> indicates that purchasing is allowed. In a part 124a enclosed between <digitalResource> and </digitalResource>, identification information is described to identify a purchasable content. In this example, CD album data is specified by “urn:musicChannel1:music1”.

In a part 125a enclosed between <sx:fee> and </sx:fee>, information associated accounting is described. In the part 125a, a fee is prescribed in a part 126a enclosed between <sx:paymentPerUse> and </sx:paymentPerUse>. In this example, the fee is set to 1500 yen. In a part 127a enclosed between <sx:to > and </sx:to >, an accounting server is specified. In this specific example, “paymentService.gazo.com” is specified as the accounting server.

In a part 121b enclosed between <grant> and </grant>, rights associated with purchasing of MP3 data are described. Similarly, line 123b indicates that purchasing is allowed, and line 124b indicates what a content (MP3 in this specific example) is purchasable. Information associated with accounting is described in a 125b. In a part 126n, the fee is set to 100 yen. In a part 127b, an accounting server is specified.

Sixth Modification

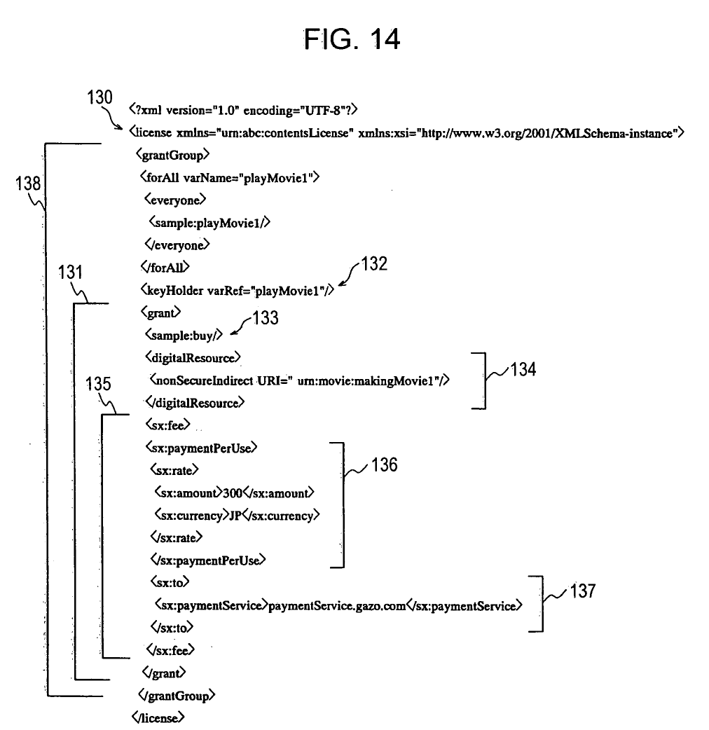

In this sixth modification, a making content of a movie content is allowed to be purchased. In this case, the making content is correspondence information. FIG. 14 is a diagram showing an example of usage rule metadata in which purchasing of making contents is prescribed. In the example shown in FIG. 14, the usage rule metadata indicates that a user, who has a dedicated terminal of registered in “metadata acquisition contract class (group1) and who has viewed a movie content (urn:movie:movie1), is allowed to purchase making (urn:movie:makingMovie1) of this movie at 300 yen, and also indicates that payment is performed on a post-payment basis.

Data elements of the usage rule metadata are described below. In line 130 starting with <license, a root of the usage rule metadata is described. In a part 138 enclosed between <grantGroup> and </grantGroup>, rights are described for respective groups.

In line 132, “playMovie1”/indicates a user the license is granted to. In this example, license is granted to a user registered. In contract class of “playMovie1”. In a part 131 enclosed between <grant> and </grant>, what is granted is described.

In line 133, <sample:buy/> indicates that the right for purchasing is granted to the user. In a part 134 enclosed between <digitalResource> and </digitalResource>, identification information is described to identify a purchasable content. In this example, a making movie is specified by “urn:movie:makingMovie1”.

In a part 135 enclosed between <sx:fee> and </sx:fee>, information associated accounting is described. In the part 135, a fee is prescribed in a part 136 enclosed between <sx:paymentPerUse> and </sx:paymentPerUse>. In this example, the fee is set to 300 yen.

In a part 137 enclosed between <sx:to > and </sx:to>, an accounting server (the accounting server 31 in the present embodiment) is specified. In this specific example, “paymentService.gazo.com” is specified as the accounting server.

The embodiment and modifications described above provide the following advantages. (1) Content providers can provide a new service associated with secondary use of distributed contents (such as extraction of a still image from a motion picture content). (2) Users are allowed to extract a still image of a scene from a motion picture content and display the extracted still image on a large-size display. This makes it possible to use the large-size display at a room interior design. (3) A playback apparatus, on which a new function of secondary use of contents is implemented, is very competitive in sales with other playback apparatus.

1. (canceled)

2. A playback apparatus comprising:
content reception means for receiving a content;
usage rule acquisition means for acquiring a usage rule of the content;
playback means for playing back the received content;
designation acceptance means for accepting designation of a particular part of the content played back by the playback means; and
corresponding information acquisition means for acquiring corresponding information which corresponds to the designated particular part and which is capable of being played back by the playback means within the limit prescribed in the acquired usage rule.

3. A playback apparatus according to claim 2, wherein the corresponding information acquisition means acquires the corresponding information by extracting the corresponding information from the content.

4. A playback apparatus according to claim 2, further comprising particular part designation information transmission means for transmitting designation information designating the particular part to the content server,
wherein the corresponding information acquisition means receives, from the content server, corresponding information corresponding to the particular part designated by the transmitted designation information.

5. A playback apparatus according to claim 2, wherein:
the content reception means receives, together with the content, a plurality of pieces of related information related to the content; and
the corresponding information acquisition means acquires related information corresponding to the designated particular part as the corresponding information.

6. A playback apparatus according to claim 2, wherein:
the content reception means receives, together with the content, a plurality of pieces of encrypted corresponding information related to the content,
the playback apparatus further comprises:
decryption key request means for requesting the content server to provide a decryption key to be used to decrypt related information corresponding to the designated particular part; and
decryption key reception means for receiving the requested decryption key from the content server, and
the corresponding information acquisition means acquires the corresponding information by decrypting, using the received decryption key, the related information corresponding to the designated particular part.

7. A playback apparatus according to claim 2, further comprising:
corresponding information usage rule acquisition means for acquiring a corresponding information usage rule of the acquired corresponding information; and
corresponding information transmission means for transmitting the corresponding information and the acquired corresponding information usage rule to another playback apparatus.

8. A playback apparatus according to claim 2, further comprising:
history information generation means for generating history information in terms of acquisition of corresponding information; and
history information transition means for transmitting the generated history information to the accounting server.

9. A content server for transmitting a content to a playback apparatus that receives the content and a usage rule of the content, accepts designation of a particular part of the received content during playback of the content, and acquires, within the limit prescribed in the received usage rule, corresponding information which corresponds to the designated particular part and which is capable of being played back, the content server comprising:
content transmission means for transmitting a content to the playback apparatus; and
usage rule transmission means for transmitting a usage rule of the content to the playback apparatus.

10-12. (canceled)

13. A usage rule server for transmitting a usage rule to a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the usage rule server comprising:
identification information reception means for receiving identification information identifying a content from the playback apparatus; and
usage rule transmission means for retrieving a usage rule corresponding to the received identification information and transmitting the retrieved usage rule to the playback apparatus.

14. An accounting server for performing an accounting process based on history information in terms of acquisition of corresponding information performed by a playback apparatus that receives a content and a usage rule of the content, accepts designation of a particular part of the received content during playback of the content, and acquires, within the limit prescribed in the received usage rule, corresponding information which corresponds to the designated particular part and which is capable of being played back, the accounting server comprising:
history information acquisition means for acquiring the history information; and
accounting means for performing the accounting process based on the acquired history information.

15-41. (canceled)
